(19) United States
(12) Patent Application Publication
(10) Pub. No.: US 2012/0206647 A1
(43) Pub. Date: Aug. 16, 2012

(54) SYSTEM AND METHOD FOR TAGGING STREAMED VIDEO WITH TAGS BASED ON POSITION COORDINATES AND TIME AND SELECTIVELY ADDING AND USING CONTENT ASSOCIATED WITH TAGS

(75) Inventors: Austin Allsbrook, Newport Beach, CA (US); Michael Barcellos, Exeter, CA (US); Adam Haslip, San Diego, CA (US); Daniel Sibitzky, Salem, VA (US)

(73) Assignee: Digital Zoom, LLC, San Diego, CA (US)

(21) Appl. No.: 13/175,227

(22) Filed: Jul. 1, 2011

Related U.S. Application Data
(60) Provisional application No. 61/398,827, filed on Jul. 1, 2010.

(51) Int. Cl. H04N 5/04; H04N 7/00

(52) U.S. Cl. 348/461; 348/E05.009

(57) ABSTRACT

A system and method are provided to tag and identify content in the form of streaming video and other media. The tags are applied by location and time coordinates corresponding to the content of the streaming video. The tags are used for identifying, requesting, using and adding to such tagged items. For this purpose, the present invention is directed to a web based media content player and backend servers loaded with tagged streaming video and other media content. The media content player loads and plays the streaming video, including tags identifying items in the content, such as songs, locations, characters, products and individuals. The system and method provide a variety of uses for the tagged content.

The present application claims the benefit and priority of and incorporates by this reference U.S. application No. 61/398,827 filed provisionally with the USPTO on Jul. 1, 2010.

### FIELD OF THE INVENTION

The present invention pertains to systems and methods that are useful for playing video streams and interactively viewing content based on tags in the video streams based on location and time coordinates.

### COMPUTER PROGRAM LISTING APPENDIX

Pursuant to 37 CFR 1.96 and 37 CFR 1.77(b)(5), the computer program listings identified below were submitted with U.S. application No. 61/398,827 filed Jul. 1, 2010 on a single compact disc and are incorporated herein by this reference. The compact disc is submitted in duplicate as Copy 1 and Copy 2 and identified and labeled in accordance with 37 CFR 1.52(e). The names of the files contained on the compact disc, their date of creation and their sizes in bytes are listed below. These further describe the references to code and invention described herein.

htdocs

/ ajax: 8/17/2009

| | |
|---|---|
| - add_favorite.php 6/17/2009 | 4kb |
| - add_product_comment.php 6/17/2009 | 4kb |
| - add_thread_post.php 6/30/2009 | 4kb |
| - add_user_comment.php 6/30/2009 | 4kb |
| - add_video_comment.php 6/16/2009 | 4kb |
| - change_language.php 6/16/2009 | 4kb |
| - get_cookie.php 6/08/2009 | 4kb |
| - path.php 6/08/2009 | 4kb |
| - profile.php 6/20/2009 | 4kb |
| - rm_favorite.php 6/08/2009 | 4kb |
| - save_video_details.php 6/17/2009 | 4kb |
| - thread.php 6/30/2009 | 4kb |
| - upload_avatar.php 7/01/2009 | 4kb |
| - upload_product_image.php 6/30/2009 | 4kb |
| - video.php 6/22/2009 | 4kb |
| - video_edit.php 6/08/2009 | 4kb |

/ C 8/17/2009

| | |
|---|---|
| - change_password.php 6/08/2009 | 4kb |
| - edit_post.php 6/30/2009 | 4kb |
| - maintenance_mode.php 6/30/2009 | 4kb |
| - req_item.php 6/30/2009 | 4kb |
| - tag_item.php 6/30/2009 | 4kb |
| - update_information.php 6/30/2009 | 4kb |
| - update_video.php 6/30/2009 | 4kb |
| - upload_avatar.php 6/09/2009 | 4kb |

/ Avatars 8/17/2009

| | |
|---|---|
| - I_.jpg 7/01/2009 | 24kb |
| - I_0.jpg 7/01/2009 | 24kb |

- l_886d295f2f2b829e22b129944a999396.jpg 7/01/2009

12kb

- l_2264e9beb28223244121a66265219fd4.jpg 7/01/2009

12kb

- l_229979fce5174c17d4645bf8752dae1e.jpg 7/01/2009

16kb

- l_e2a98b3a033592010df72c40f8c9ad1f.jpg 7/01/2009

12kb

| | |
|---|---|
| - s_.jpg 7/01/2009 | 16kb |
| - s_0.jpg 7/01/2009 | 16kb |

| | |
|---|---|
| - s_886d295f2f2b829e22b129944a999396.jpg 7/01/2009 | 4kb |
| - s_2264e9beb28223244121a66265219fd4.jpg 7/01/2009 | 8kb |
| - s_229979fce5174c17d4645bf8752dae1e.jpg 7/01/2009 | 8kb |
| - s_e2a98b3a033592010df72c40f8c9ad1f.jpg 7/01/2009 | 4kb |

/ CSS 8/17/2009

| | |
|---|---|
| - global.css 7/01/2009 | 20kb |
| - uploadify.styling.css 5/30/2009 | 4kb |

/ IMG 8/17/2009

/ buttons 6/27/2010

| | |
|---|---|
| - accept.png 3/12/2006 | 4kb |
| - add.png 3/12/2006 | 4kb |
| - addfav.gif 4/19/2009 | 4kb |
| - delete.png 3/12/2006 | 4kb |
| - lBl.gif 3/31/2009 | 4kb |
| - lbR.gif 3/31/2009 | 4kb |
| - lbTX.gif 3/31/2009 | 4kb |
| - rmFav.gif 4/19/2009 | 4kb |

/ front_banners 6/27/2010

```
- 01.jpg 6/30/2009
  168kb
- 02.jpg 7/01/2009
  152kb
- house.jpg 5/26/2009
  60kb
- newPollution_sides.png 5/08/2009
  356kb
- newPollution.jpg 5/07/2009
```

92kb

```
- redPollution_sides.png 5/08/2009
  312kb
- redPollution.jpg 5/07/2009
  104kb
- theOffice.jpg 5/26/2009
```

64kb

/ resc 6/27/2010

| | |
|---|---|
| - bl01.jpg 5/27/2009 | 4kb |
| - dg01.jpg 5/27/2009 | 4kb |
| - dh01.jpg 5/27/2009 | 4kb |
| - hr.jpg 5/27/2009 | 4kb |
| - px01.jpg 5/27/2009 | 4kb |

/ right_column 6/27/2010

| | |
|---|---|
| - iCap.gif 4/01/2009 | 4kb |
| - iQuote.gif 3/20/2009 | 4kb |
| - rightColumnSeperator.gif 4/1/2009 | 4kb |
| - rQuote.gif 3/20/2009 | 4kb |

| | |
|---|---|
| - advertise.jpg 3/31/2009 | 32kb |
| - ajaxsmall.gif 4/19/2009 | 4kb |
| - betabg.gif 4/13/2009 | 4kb |
| - betalogo.jpg 4/13/2009 | 24kb |
| - betasubmit.gif 4/14/2009 | 4kb |
| - bodybackground.gif 3/31/2009 | 4kb |
| - btn_reply.gif 7/01/2009 | 4kb |
| - cancel.png 2/17/2009 | 4kb |
| - channel_header.jpg 6/24/2009 | 92kb |
| - commmentContentBG.gif 4/20/2009 | 4kb |
| - commentContentBottom.gif 4/20/2009 | 4kb |
| - commentContenttop.gif 4/20/2009 | 4kb |
| - contentSeparator.gif 4/20/2009 | 8kb |
| - darkbg.png 4/20/2009 | 212kb |
| - dsc.gif 5/26/2009 | 8kb |
| - footerbg.gif 3/31/2009 | 4kb |
| - head.gif 4/10/2009 | 56kb |
| - head.jpg 4/10/2009 | 28kb |
| - header.png 6/19/2009 | 76kb |
| - header_repeat.gif 6/19/2009 | 4kb |
| - headseperator.gif 3/31/2009 | 4kb |
| - herospot.jpg 3/31/2009 | 35kb |
| - interestedjoin.jpg 3/31/2009 | 16kb |
| - leftcolumnseperator.gif 4/01/2009 | 4kb |
| - mainheaderstripe.gif 3/31/2009 | 4kb |
| - navbg.gif 3/31/2009 | 4kb |
| - navseparator.gif 3/31/2009 | 4kb |
| - placeholder1.jpg 4/20/2009 | 96kb |
| - placeholder2.gif 4/20/2009 | 4kb |
| - pointbuttontemplate.gif 3/31/2009 | 4kb |

| | |
|---|---|
| - product_header.jpg 6/24/2009 | 88kb |
| - rc_f.gif 4/17/2009 | 4kb |
| - rc_h.gif 4/17/2009 | 8kb |
| - rc5px.gif 5/26/2009 | 4kb |
| - rc7px.gif 5/26/2009 | 4kb |
| - rightColumnCap1.gif 4/01/2009 | 4kb |
| - rightColumnHighlighter.gif 4/01/2009 | 4kb |
| - searchbg.gif 3/31/2009 | 4kb |
| - searchbutton.gif 3/31/2009 | 4kb |
| - searchleft.png 4/25/2009 | 8kb |
| - sectionheader.gif 4/19/2009 | 4kb |
| - signupgreen.gif 5/26/2009 | 4kb |
| - star.gif 6/19/2009 | 4kb |
| - star_off.gif 6/19/2009 | 4kb |
| - whatisthisbrowse.jpg 3/31/2009 | 16kb |
| - whatisthisleft.jpg 3/31/2009 | 20kb |
| - whatisthisseparator.gif 3/31/2009 | 4kb |
| - whatisthistour.jpg 3/31/2009 | 16kb |

/ js 8/17/2009

| | |
|---|---|
| - global.js 7/01/2009 | 4kb |
| - index.js 7/01/2009 | 4kb |
| - jquery.uploadify.js 6/02/2009 | 12kb |
| - jquery-1.3.1.min.js 6/08/2009 | 4kb |
| - profile.js 6/30/2009 | 16kb |
| - thread.js 6/30/2009 | 4kb |
| - video.js 6/30/2009 | 4kb |

/ swf 8/17/2009

| | |
|---|---|
| - uploader.swf 6/02/2009 | 20kb |

/player 8/17/2009

| | |
|---|---|
| - player.swf 6/30/2009 | 76kb |
| - productstyle.css 6/30/2009 | 4kb |

| | |
|---|---|
| - 404.php 6/16/2009 | 4kb |
| - beta.php 7/01/2009 | 4kb |
| - browseproducts.php 6/22/2009 | 4kb |
| - browseproductslist.php 6/22/2009 | 4kb |
| - channels.php 6/21/2009 | 4kb |
| - favicon.ico 6/30/2009 | 4kb |
| - forgotpassword.php 6/19/2009 | 4kb |
| - forum.php 6/29/2009 | 4kb |
| - forum_thread.php 7/01/2009 | 4kb |
| - forumnew.php 7/01/2009 | 4kb |
| - index.php 4/25/2009 | 4kb |
| - legal.php 5/26/2009 | 0kb |
| - llist.php 6/22/2009 | 4kb |
| - login.php 7/01/2009 | 4kb |
| - logout.php 4/25/2009 | 4kb |
| - massemailscript.php 7/01/2009 | 4kb |
| - picture.php 4/26/2009 | 4kb |
| - plist.php 6/22/2009 | 4kb |
| - privacy.php 4/25/2009 | 4kb |
| - product.php 6/30/2009 | 4kb |

| | |
|---|---|
| - profile.php 6/20/2009 | 4kb |
| - register.php 7/01/2009 | 4kb |
| - robots.txt 4/06/2009 | 4kb |
| - scrape.php 6/29/2009 | 4kb |
| - search.php 6/09/2009 | 4kb |
| - supermanthathoe.php 7/01/2009 | 4kb |
| - terms.php 4/25/2009 | 4kb |
| - test.php 6/02/2009 | 4kb |
| - upload.php 6/19/2009 | 4kb |
| - uploadvideo.php 6/08/2009 | 4kb |
| - vdata.php 6/30/2009 | 4kb |
| - verify.php 6/19/2009 | 4kb |
| - video.php 6/16/2009 | 4kb |
| - videos.php 6/21/2009 | 4kb |
| - vlist.php 6/26/2009 | 4kb |
| - welcome.php 6/02/2009 | 4kb |

library

| | |
|---|---|
| - 5.15.09_10.46am.sql 5/15/2009 | 24kb |
| - functions.php 7/01/2009 | 12kb |
| - headers.php 4/13/2009 | 4kb |
| - init.php 7/01/2009 | 4kb |
| - recaptchalib.php 11/29/2007 | 12kb |

/ conf 8/17/2009

| | |
|---|---|
| - databas.abstract.php 5/14/2009 | 12kb |
| - database.conf.php 7/1/2009 | 4kb |
| - framework.conf.php 6/08/2009 | 4kb |
| - index.php 3/26/2009 | 4kb |
| - language_list.php 4/13/2009 | 4kb |
| - links.conf.php 6/16/2009 | 4kb |
| - user.conf.php 4/13/2009 | 4kb |

/ lang 8/17/2009

/ en 8/17/2009

- definitions.php 6/17/2009

12kb

- email.confirmregistration.txt 4/13/2009

4kb

- email.forgotpassword.txt 4/13/2009

4kb

/ sv 8/17/2009

- definitions.php 4/13/2009

8kb

- email.confirmregistration.txt 3/31/2009

4kb

- email.forgotpassword.txt 4/01/2009

4kb

/ framework 8/17/2009

| | |
|---|---|
| - class.comments.php 6/30/2009 | 4kb |
| - class.core.php 6/20/2009 | 8kb |
| - class.database.php 5/26/2009 | 4kb |
| - class.encryption.php 4/23/2009 | 4kb |
| - class.errorhandler.php 4/23/2009 | 4kb |
| - class.favorites.php 6/18/2009 | 4kb |
| - class.getscrape.php 6/29/2009 | 4kb |
| - class.listing.php 6/22/2009 | 4kb |
| - class.mail.php 4/13/2009 | 4kb |
| - class.newsqlbuilder.php 6/16/2009 | 16kb |
| - class.page.php 5/01/2009 | 4kb |
| - class.paging.php 6/30/2009 | 4kb |
| - class.phpquery.php 6/19/2009 | 164kb |
| - class.product.php 6/30/2009 | 4kb |
| - class.session.php 6/19/2009 | 8kb |
| - class.sqlbuilder.php 5/25/2009 | 20kb |
| - class.user.php 7/01/2009 | 20kb |
| - class.user_comments.php 6/16/2009 | 4kb |
| - class.video.php 6/19/2009 | 4kb |

/ pages 8/17/2009

| | |
|---|---|
| - page.beta.php 7/01/2009 | 4kb |
| - page.browseproducts.php 6/22/2009 | 4kb |
| - page.channel.php 6/22/2009 | 4kb |
| - page.channels.php 6/30/2009 | 4kb |
| - page.forgptpassword.php 4/19/2009 | 4kb |
| - page.forgotpasswordnew.php 6/19/2009 | 4kb |
| - page.forgotpasswordsaved.php 4/15/2009 | 4kb |
| - page.forgotpasswordsent.php 6/19/2009 | 4kb |
| - page.forum.php 7/01/2009 | 4kb |
| - page.forum_thread.php 7/01/2009 | 4kb |
| - page.forumnew.php 6/30/2009 | 4kb |
| - page.home.php 6/16/2009 | 4kb |
| - page.index.php 7/01/2009 | 4kb |
| - page.login.php 4/19/2009 | 4kb |
| - page.myprofile.php 8/16/2009 | 4kb |
| - page.notfound.php 6/22/2009 | 4kb |
| - page.picture.php 4/26/2009 | 4kb |
| - page.privacy.php 4/14/2009 | 8kb |
| - page.product.php 6/30/2009 | 4kb |
| - page.products.php 5/14/2009 | 4kb |
| - page.productslist.php 6/30/2009 | 4kb |
| - page.profile.php 7/01/2009 | 4kb |
| - page.register.php 7/01/2009 | 4kb |
| - page.registersuccess.php 4/13/2009 | 4kb |
| - page.search.php 6/09/2009 | 4kb |
| - page.terms.php 4/14/2009 | 28kb |
| - page.uploadvideo.php 6/20/2009 | 4kb |
| - page.verify.php 4/15/2009 | 4kb |
| - page.video.php 6/30/2009 | 4kb |
| - page.videos.php 6/21/2009 | 4kb |
| - page.welcome.php 6/02/2009 | 4kb |

| / old 8/17/2009 | |
|---|---|
| - page.index.php 5/26/2009 | 8kb |

/ usercontrols 8/17/2009

| | |
|---|---|
| - usercontrol.add_favorites.php 4/24/2009 | 4kb |
| - usercontrol.big_search.php 6/09/2009 | 4kb |
| - usercontrol.change_password.php 6/09/2009 | 4kb |
| - usercontrol.channel_right.php 6/21/2009 | 4kb |
| - usercontrol.channels.php 6/21/2009 | 4kb |
| - usercontrol.channels_json.php 5/26/2009 | 4kb |
| - usercontrol.edit_post.php 6/30/2009 | 4kb |

| | |
|---|---|
| - usercontrol.footer.php 6/21/2009 | 4kb |
| - usercontrol.forum_right.php 6/30/2009 | 4kb |
| - usercontrol.forum_thread_right.php 6/30/2009 | 4kb |
| - usercontrol.header.php 7/1/2009 | 8kb |
| - usercontrol.index_feed.php 6/19/2009 | 4kb |
| - usercontrol.login_right.php 7/01/2009 | 4kb |
| - usercontrol.main_right.php 4/20/2009 | 4kb |
| - usercontrol.maintenance_mode.php 7/01/2009 | 4kb |
| - usercontrol.myprofile_right.php 6/20/2009 | 4kb |
| - usercontrol.panel_added.php 7/01/2009 | 4kb |
| - usercontrol.panel_popular.php 7/01/2009 | 4kb |
| - usercontrol.product_categories.php 6/22/2009 | 4kb |
| - usercontrol.product_category.php 6/22/2009 | 4kb |
| - usercontrol.profile_right.php 4/20/2009 | 4kb |
| - usercontrol.quote.php 7/01/2009 | 4kb |
| - usercontrol.request_item.php 6/30/2009 | 4kb |
| - usercontrol.tabbed_panels.php 6/30/2009 | 4kb |
| - usercontrol.tag_item.php 6/30/2009 | 4kb |
| - usercontrol.update_information.php 7/01/2009 | 4kb |
| - usercontrol.update_video.php 6/21/2009 | 4kb |
| - usercontrol.upload_avatar.php 6/08/2009 | 4kb |
| - usercontrol.video_right.php 6/30/2009 | 4kb |
| - usercontrol.videos_right.php 6/21/2009 | 4kb |

### BACKGROUND OF THE INVENTION

Tags in media content have the function of identifying content (e.g., video, video segments, music, music segments, pictures, pages, etc). Tags can be applied by content providers, as well as users of content. Users can be provided with a graphical user interface through which they can apply tags. In the specific context of streaming video, tags may be similarly applied. The tags may hyperlink to segments within the streaming media.

However, it would be desirable to tag (identify) streaming video content at specific points within the content. It would be desirable to tag content based on location and time corresponding to the displayed content. It would further be desirable to provide a system that provides user options to view, select, use and modify such tags for purposes of information, sharing, entertainment and commerce.

In light of the above, it is an object of the present invention to provide a system and method for creating and providing tagged content in streaming video and other media, wherein tags are applied in accordance with the time and location coordinates of the content. It is a further object of the present invention to provide additional identifying information about the content in association with the location and time coordinates. Another object of the present invention is to provide a system and method for providing a web based media content player for identifying and requesting such tagged items in streaming video content, such as songs, locations and individuals. Still another object of the present invention is to provide a system and method for providing a web based media content player and backend servers and databases that provide for displaying, identifying, selecting and reviewing content of and associated with such tagged items in streaming video content. Still another object of the present invention is to provide a system and method for providing a web based media content player and backend databases and servers that provide for requesting and adding to tagged items in streaming video content. Still another object of the present invention is to provide a system and method for all of the above that is simple to use, relatively easy to manufacture, and comparatively cost effective.

### SUMMARY OF THE INVENTION

In accordance with the present invention a system and method are provided to tag/identify content in the form of streaming video and other media. The tags are applied by location and time coordinates corresponding to the content of the streaming video. The tags are used for identifying, requesting, using and adding to such tagged items. For this purpose, the present invention is directed to a web based media content player and backend servers loaded with tagged streaming video and other media content. The media content player loads and plays the streaming video, including tags identifying items in the content, such as songs, locations, characters, products, individuals, etc. The system and method provide a variety of uses for the tagged content.

More particularly, in connection with streaming video or other media content, the media content player is concurrently provided with access to an item identification database and an array of item identifiers for the items tagged and identified in the media file. All items within the item identification database are associated with an x, y position and time coordinate of a specific media file and potentially a plurality of media files. When a selected streaming video playing on the media content player file reaches a pre-determined time coordinate marker, an event occurs in response. Namely, an item marker animates on screen at the x, y coordinates and time cataloged within the item identification database. Additional information about that specific item is also displayed or available for further review.

For example, at the example predetermined time, a thumbnail and brief description of the corresponding particular item is made available in an item queue positioned by the displayed video of the media content player. Thus, a user can review the tagged item information in detail. At this point, if a user chooses to examine the individual item selected in greater detail, the user may select the product thumbnail that accesses a more descriptive page of information (i.e., link library, website, html web page). The system allows the user to click into that item's detailed information landing page via a hyperlink e.g., a reference and transactional landing page or lead capture page). Within the landing page for a tagged item, the invention provides an item photograph, detailed description and additional details. The foregoing action repeats for all items associated with streaming media delivered through the media content (video) player.

As a result, the media content player and identification database and software create an environment that allows for both pre-defined and user-defined item information. Pre-defined information is information stored on backend servers and databases, such as for a library of media files. Pre-defined information could include product placement identification information, for example. User-defined information is information identified and or requested by users of the system. Accordingly, this provides at least three applications for the system. First, the invention provides predefined backend system tagged information in the item identification database associated to media (video) content provided by media content servers to media content players. Second, the invention provides user defined tagged content, which is added to the item identification database to add to the predefined tag content or to provide tags for user provided media content. Third, the invention provides user defined requests for additional information about tagged items.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic presentation of system components of the present invention;

FIG. 2 is a figurative schematic presentation of system components of the present invention;

FIG. 3 is a schematic presentation of the display of the media content player of the present invention;

FIG. 4 is a schematic presentation of the x, y and time (t) coordinates used to tag and identify items in media of the present invention;

FIG. 5 is an illustration of a screen displayed by the media content player of the present invention;

FIG. 6 is a schematic presentation of system components of the present invention;

FIG. 7 is a flowchart of selection and play steps and components of the present invention;

FIG. 8 is a flowchart of user tagging steps and components of the present invention;

FIG. 9 is a flowchart of user requesting steps and components of the present invention.

### DESCRIPTION OF THE PREFERRED EMBODIMENTS

Tags are metadata terms or other data assigned to computer files to identify or describe an aspect of the content of the files and then later used to find the content by using the tags. Tags may be chosen and assigned by content providers or by users of tagged files. In the present invention, tags are preferably applied to media files, such as video files. Video files have a timeline from beginning to end and a series of images (e.g., video frames or renderings) with display information distributed along that timeline. In the present invention, the tags are applied in accordance with the point in time in the media file selected for identification tags. Importantly, tags are also applied in accordance with x and y coordinates of an item in a given video image at that time (e.g., video frame or rendering or set of frames or renderings). For example, if a video file displays a particular actor at a particular time, a tag is created for the video file that identifies that actor with the x and y coordinates where and when the actor appears in the video (e.g., at first appearance, at significant point of appearance, etc.). Such tags may include additional information, such as the name of the actor or the actor's character. Such tags may also refer to additional fields, records and files containing additional information about the item, so that a large variety of information can be provided about the item and located by the tag.

Accordingly, in the present invention, video files, such as movies, television programming, music videos, advertisements, etc., are tagged to identify items of interest in the content, including, for example, actors, locations and products, at the particular time and location that the item appears in the video. Preferably, libraries of videos are prepared with corresponding databases containing such tags, predefined by the providers of the system (predefined information). Users of the system then can view the videos and see the tags and information about each item identified. Users can also add more tags and information about items (user-defined information). The tags are associated with content in accordance with timelines of and items in the videos. Databases are created with the tags to be used with the videos. When the videos are to be streamed, media content (video) player is provided access to the streaming video and the tags associated to the video. As the video streams, the tags are accessed at the times of the video associated with each tag. The content player is instructed to display the tag at the x, y coordinate associated with the streaming content. As such, users see the tags and information about the item tagged. When a selected streaming video playing on the media content player file reaches a pre-determined time marker, an item marker responsively animates on screen at the x, y coordinates tagged within the item identification database. Additional information about that specific item is also displayed or available for further review.

In operation, several items are tagged in a streaming video. The information concerning those items (e.g., time, x, y location, words, statements, facts and other information identifying the item) are stored on backend servers and databases. Streaming video is then provided by these servers to the content player in accordance with a request conveyed by the content player. The location of the tags is shown on the streaming video on the display of the content player. Visual tags or spots indicate each identified item on the display. The display can also include words, such as the name of an item that displays momentarily on the video. Thumbnails show additional information about each tagged item. Users can view information about these tagged items and follow the information to locations with more information about the items, such as websites. Users can add new information about tagged items and add new tags and information about newly tagged items.

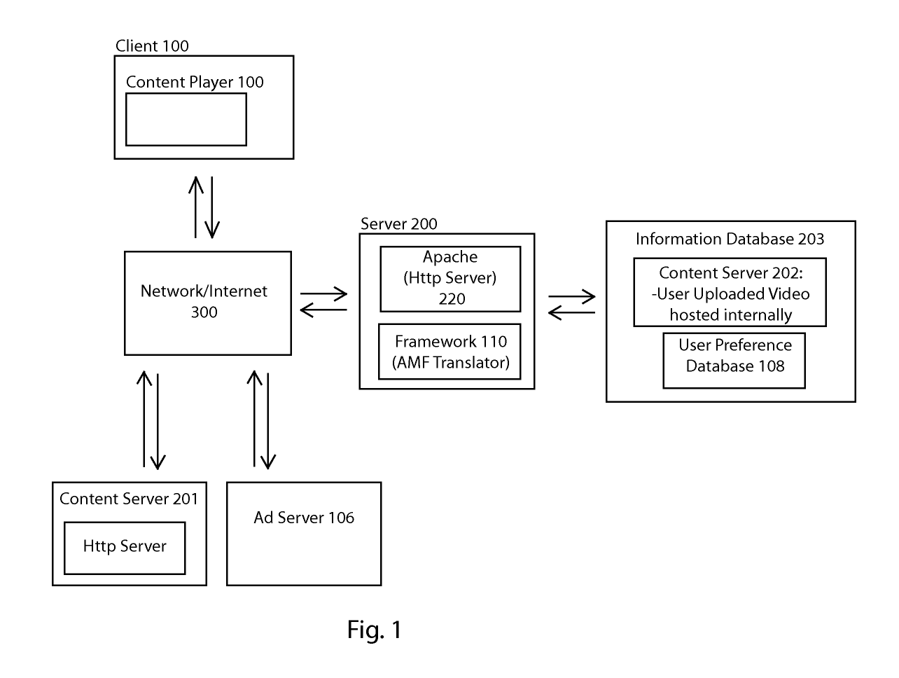

Referring to FIG. 1, to provide this interactive environment, the system of the present invention is characterized in accordance with three sides (i.e., levels, layers, platforms)—the client 100, the server 200 and the network 300. Server 200 comprises servers communicating via a network 300 with client side 100 comprising computers and their users. Such computers include laptops, personal computers, smart mobile devices and desktop applications. Such computers include displays and input means. Server side 200 directs streaming content to such computers on client side 100.

Computers on client side 100 display a content player 101 (e.g., a video player, media content player, etc.) hosted and provided by server side 200 (e.g., via a website). As such, content player 101 may operate on the computers, but be provided and maintained by backend server 200 side applications (e.g., as a server provided application that loads in whole or part on the user device for operation). Content player 101 is preferably a dynamic streaming content player with modules integrated to use and display predefined and user defined tagged item identification information. The modules are integrated with content player 101 and the hosting website for tagging, requesting and displaying items on streaming video.

As shown in FIG. 1, client 100 is in communication with server 200 via network 300. In addition to servers and associated processors, server 200 also comprises databases and memory that are all collectively characterized herein as “backend.” Network 300 comprises network communication infrastructure to support communication between client 100 and server 200, such as Internet communication systems, landline communication systems, and wireless communication systems.

Server 200 includes at least one main server and processor arrangement 220 for control (aka, server/processor arrangement 220). Server/processor arrangement 220 can comprise any well known content server and processor system capable of several processing, control and integration functions. These include processing command, signal input/output instructions and software programming for controlling and integrating components of the system on server side 200 with client 100. Server/processor arrangement 220 is also capable of providing and controlling website content and communications. This includes provision of website and website information and communications from server side 200 to client side 100. Server/processor arrangement 220 is also capable of controlling content servers 201 (and 202, see below; and content provided from third party content servers, etc.) and ad server 106 to provide streaming video streaming to content player 101. Server/processor arrangement 220 is also capable of controlling item information database 203 and user preference database 108 to provide item information corresponding to videos to be streamed. Server/processor arrangement 220 is also capable of receiving and responding to signal inputs from content players 101. Server/processor arrangement 220 is also capable of receiving and responding to signal inputs from item information database 203 and user preference database 108. This includes provision of the core application software to content player 101 on computers on client side 100. Accordingly, server/processor arrangement 220 provides processing, server, control and integration functions for the system.

Server/processor arrangement 220 preferably includes at least one HTTP server and a processor utilizing Apache operating system (a Linux based operating system) to control servers and with capability to read/process HTTP language for processing. More specifically, this includes processing software programming and providing instruction and control for integrating components on server side (e.g., see “Apache HTTP Server” block in FIG. 1 at server 200 side which indicates a server/processor arrangement 220) and receiving input from client side 100.

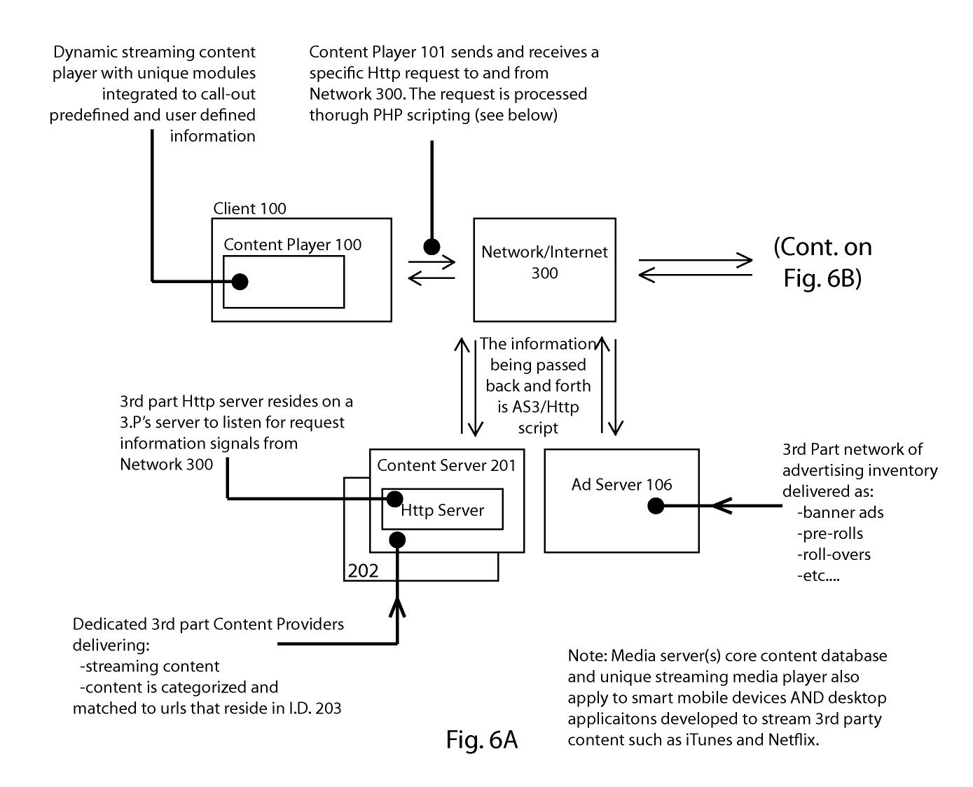

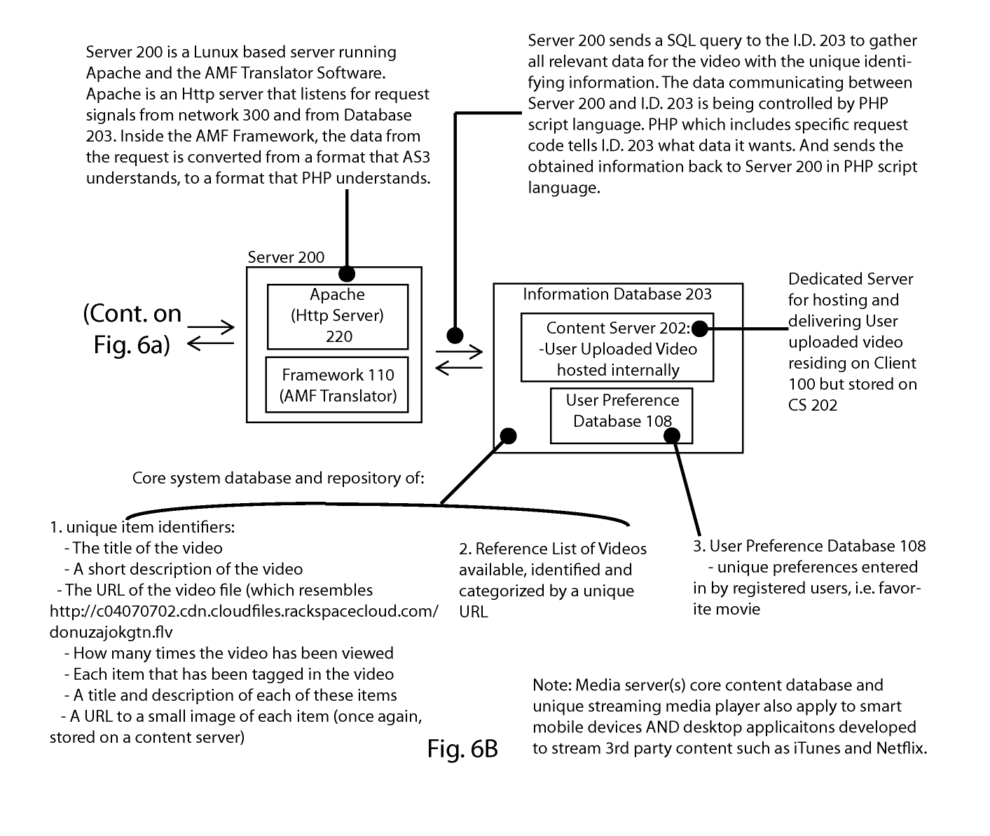

As also shown in FIG. 6 and referenced above, server side 200 also comprises at least one dedicated content server 201. Content server 201 is for streaming user requested media, such as videos. Server side 200 comprises servers as well for providing other content (e.g., ad server 106, additional content server 202 for user provided media content). These servers preferably operate in accordance with controls from server/processer arrangement 220. Content server 201 (and other servers) can comprise any well known content server system capable of storing and providing streaming video and other media files to content players 101 as directed.

Server side 200 also includes an item identification database 203 (aka item information identification database 203) and other databases (e.g., user preference database 108 as shown in FIG. 6). These databases are for storing and retrieving information about tagged items and users of the system. Memory is associated with these databases for storage. Item identification information database 203 is the repository of tagged and identified items. As such, item identification database 203 is for storing and retrieving item information pertaining to specific media files to be streamed to content players 101. User preference database 108 is for storing and retrieving user information pertaining to specific users of the content players 101.

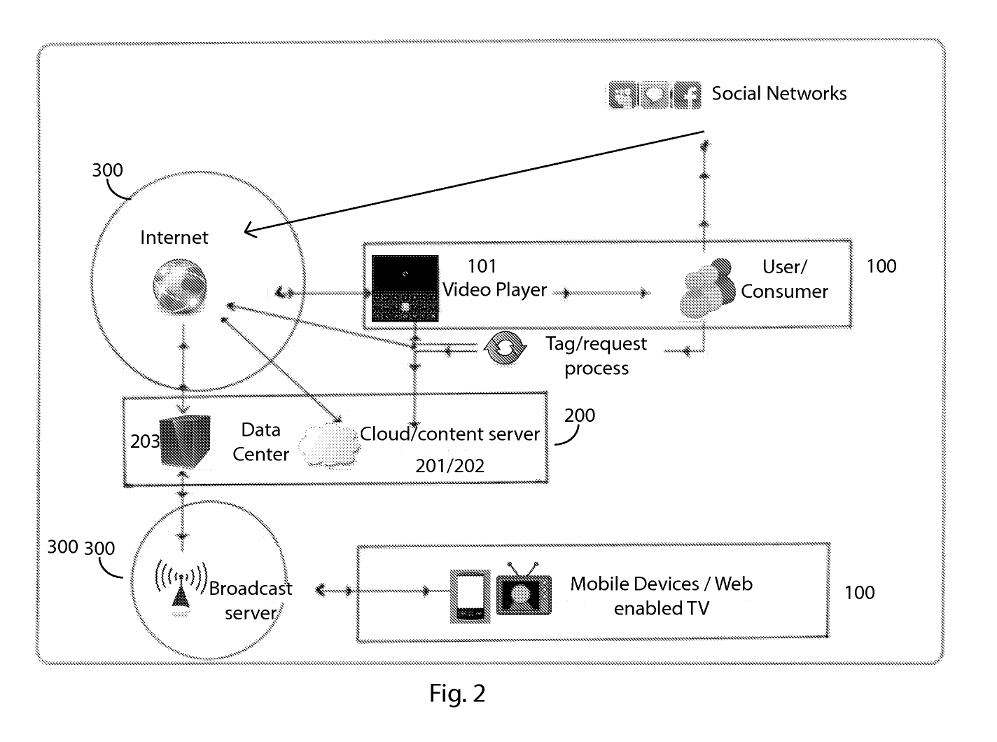

The components of FIG. 1 will be discussed in more detail below in connection with FIG. 6 after the following descriptions of FIGS. 2-5.

As shown in FIG. 2, client 100 is in communication with server 300 via network 200. Client 100 includes content player 101 to play streaming video, and users can tag and request items on client side 100. Client side 100 can include mobile devices and web enabled television. Users can use the system of the present invention and tagged content in connection with social networks. Server side 200 includes content servers 201 and other servers, which can comprise cloud servers, and item identification database(s) 203, which can reside at and/or comprise data center(s). Network 300 includes Internet links but can include broadcast transceivers and servers as well.

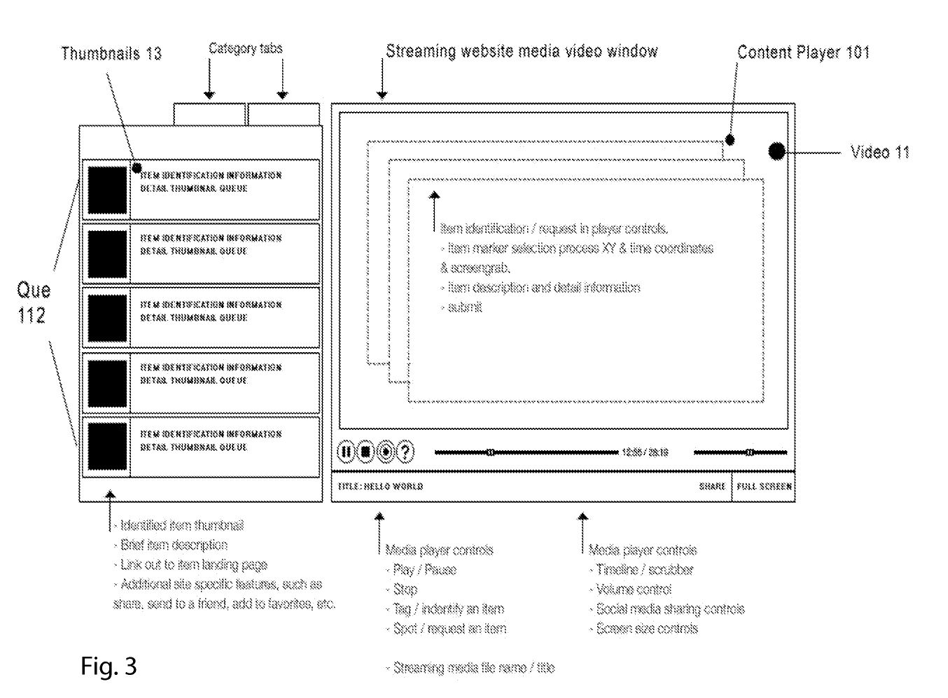

As shown in FIG. 3, the layout of a user's screen using the content player 101 and hosted website of the present invention is generally comprised of a space for displaying streaming video 11 and a space for thumbnails 13. Thumbnails 13 provide information about identified items (tagged items), such as a brief description of the item, a link to a landing page about the item (hyperlink to product webpage), and additional website features such as the ability to share, send to a friend, add to favorites, etc. Various tabs and titles are incorporated into the website and content player 101 to enhance the user experience, such as category and status tabs, name, title and time of the streaming video and control tabs for content player 101. Content player 101 includes basic player controls such as play, pause, and stop. Content player 101 and the hosting website further include user defined functions such as tag/identify an item and spot/request an item. Content player 101 and the website also include media content player controls such as a timeline/scrubber, volume, social media sharing and screen size.

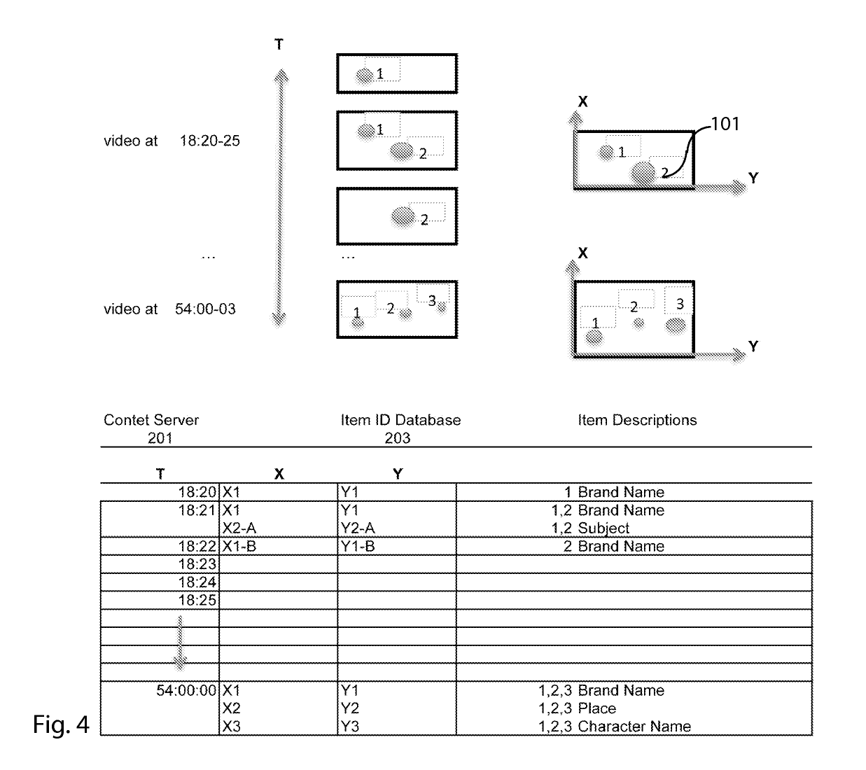

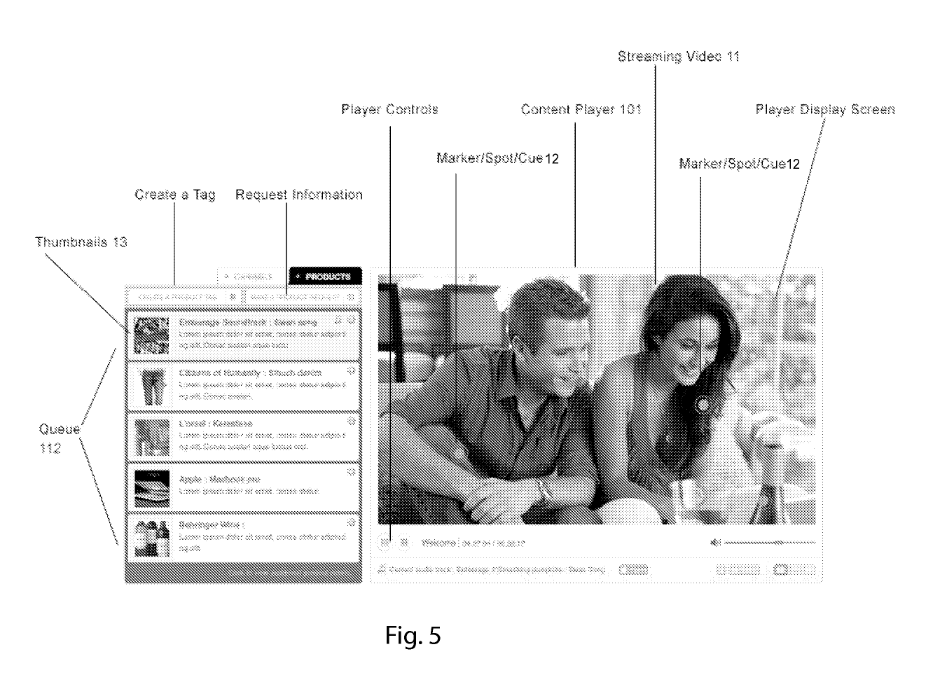

FIG. 4 illustrates use and arrangement of x and y coordinates and time to tag items and to display those tags in images (e.g., video frames and sets of video frames or renderings). As discussed above and shown in FIG. 4, at selected times and locations, each media file (e.g., video) is played in accordance with a timeline and a series of images. Each image has x and y coordinates for locations and at coordinate for time. Images are tagged based on the time t of the image and x and y coordinates of an item displayed within the image. Tags with those coordinates are stored in an array or database (e.g., item identification database 203). Those time and location coordinates are associated to the video streamed by content player 101 (shown in FIGS. 3, 5) in accordance with the timeline of the video. X, y coordinates for each time coordinate of a tag further correspond to x, y locations on the display of the video rendering for the video at that time. Multiple items can be tagged at one time within one image or a series of images. As shown in FIGS. 4 and 5, tags are preferably rendered on the video image as spots.

Accordingly, as shown, for time 18:20-22 associated to the given streaming video, a first spot “1” appears at time 18:20. Spot “1” is associated with an item in the video, such as an actor. Note the block behind spot “1,” which indicates additional information rendered there (e.g., the name of the item identified by the spot, “famous actor john smith”). Continuing with the video timeline t shown in FIG. 4, a second spot “2” also appears during time 18:21. At 18:21, first spot “1” and second spot “2” remain through time 18:22. As shown also in FIG. 4, spot “2” changes x, y location between 18:20 and 18:21. Item information database 203 includes data for each x, y location at each different time t (see table at the bottom of FIG. 4). During time 54:00-03, three spots (“1,” “2” and “3”) are displayed. Each spot is for a different item at a different time. These spots correspond to tagged items. For each item, several terms or descriptors are stored in item information database 203 and associated to time t. Time t is also in item information database 203, and time t is also associated to video streamed by content server 201. As shown, time t is a unifying point of reference between the video content (media file streamed by content player 201) and the items of information in the item identification information database 203 (e.g., time t for the time slot of the video (or media file), locations x, y for each item tagged/identified, item descriptors for each item tagged/identified). So, with identification of time t for the video, the x, y locations of the spot and tagged/identified item can be associated to the video. They (both the media content and the item identification information) are accessed on the backend (server side 200). They are unified at time t in the display of content player 101. In other words, at time t of the streaming video, item information database 203 provides the x, y and item descriptors for each tagged/identified item.

As such, as indicated in FIG. 4 and described further below, for a selected video to be streamed, the system loads the video and all information from item information database 203 corresponding to that video. Then, when the video plays and displays on content player 101, the information from item information database 203 is also displayed. The content player 101 is in communication with the backend server 200 to run modules or components to display the spot (aka, marker, cue) and the item descriptors in the display of the content player 101.

Continuing in more detail, as shown in FIG. 4, with identification of time t for the video, item descriptors in corresponding rows or fields of item information database 203 are accessed from item information database 203 in accordance also with x, y. The x, y information is used to display the spot and item descriptors on the display of content player 101 on client side 100. The item identification information may be displayed elsewhere on the display of content player 101 and elsewhere on the website on which the content player 101 is hosted (e.g., the thumbnails 13 and queue 112 shown in FIG. 5).

FIG. 5 is an illustration of a video streaming and shown at a particular time. FIG. 5 is shown from the perspective of a user of the system. FIG. 5 is a sample screen shot of display provided by the content player 101 and the underlying website. Within the content player 101 window playing the streaming video 11, FIG. 5 illustrates several items tagged at the time of the video 11 shown. For example, these include denim jeans worn by one actor, hair product associated to the other actor, a laptop computer and a bottle of wine, as well as the current audio track for the video. The location of the tags is shown on the video as concentric circle spots 12 located on each identified item. Although not shown, the display of the spot 12 on the video 11 can also include words, such as the name of an item that displays momentarily on the video 11.

The display of content player 101 on client side 100 also includes the information queue 112 to the left of the display of the content player 101. As referred to above and described further below, the system loads the content from the item identification information database 203 to queue 112, and more particularly to thumbnails 13, upon the successful arrival of a pre-determined time of the media file. As shown, to the left of the video 11, thumbnails 13 show additional information about each tagged item. Users can follow the information to loading platforms (i.e. html web pages, PHP web pages, etc.) with even more information about the item, such as websites for each item. Users can add new information about tagged items. Users can add new tags and information about newly tagged items. Also, users can view these tags and information about the items tagged, and FIG. 5 shows controls for content player 101 for these purposes.

Continuing in detail in view of FIG. 6, the server side 200 of the system comprises an AMF framework translator 110 (aka, framework 110) in communication with server/processor arrangement 220. Via server/processor arrangement 220, framework 110 provides communication channels between the content player 101, on the one hand, and the content server 201 (and ad server 106 and other servers) on the other. Similarly, via server/processor arrangement 220, framework 110 also provides communication channels between the content player 101 and item information database 203 and user preferences database 108 (and databases).

Framework 110 is preferably written in Zend AMF to facilitate Adobe's Action Message Format protocol. AMF open source code translator is used to facilitate discussion between the content player 101 and backend servers, including importantly via server/processor arrangement 220 (e.g., Action Script3 & PHP/LAMP server). However, other frameworks and open source can be used.

Content server 201 and ad server 106 are for serving (accessing, loading for streaming, transmitting) media files. Item information database 203 and user preferences database 108 are for storing and providing item and user information. Memory is incorporated with content server 201, ad server 106, item identification database 203, user preference database 108 and, importantly, server/processor arrangement 220 for storing and retrieving information and data. This information and data includes but is not limited to media files, fields, links, instructions and programming. Software is incorporated for operating these and other components of the system. Processors are included for computing and processing software programs, instructions, commands and other signals. Information is provided from server side 200 in response to user inputs and signals to content server 201 and item identification information database 203 via server/processor arrangement 220 and framework 110.

Software and tools used in connection with the server/processor arrangement 220, content server 201, ad server 106, item identification database 203 and user preference database 108 of server 200 and the content player 101 of client 100 preferably include Adobe Flash /Action Script 3/PHP script. In alternative embodiments, content player 101 and content server 201 and controls for accessing and using item information identification database 203 in accordance with server/processor arrangement 220 may also be written in canvas (html5) and other languages and operating systems.

Additional support of AMF framework 110 and code libraries through Robotlegs provide decoupled functionality. This includes application architecture, player controls and modular expansion environment. Robotlegs is an inventory file system for pulling up categorized content. HTTP://www.robotlegs.org/. For example, Robotlegs is useful for thumbnails I 13 and information queues 112.

Gutter Shark is preferably used in connection with providing AMF framework 110 (e.g., for GTD information management) to simplify the Action Script 3 API (i.e., style sheets, text formatting, preloading, bindings, assets, audio management, event management, keyboard events, display object layouts.) HTTP://codeendeavor.com/guttershark.

As referenced above, client 100 comprises in part the user interface components of the system, such as the user's computer (e.g., laptop, mobile media device) capable of displaying streaming content. Content player 101 resides at least in part and temporarily on the user's computer. However, content player 101 is preferably accessed and operated via the host website provided via server 200 which provides links to content player 201 (e.g., similar in that respect to various online applications, including streaming applications, such as YouTube). Accordingly, content player 101 is described herein in connection with client 100 to illustrate the user interface. Via the website, content player 101 plays on user's computer when connected online to server 200 via network 300 in accordance with the AMF framework 110. Content player 101 receives inputs and partial processing by the user's computer for operation specific to that user. Operation of content player 101 and website is specific to the user based on user inputs and preferences. Backend control of content player 101 is provided by processing of server side 200. Server/processor arrangement 220 provides processing, controls and integration.

Content player 101 may comprise a standard web based video player that features all basic media content player controls including, play/pause volume control, full-screen, and time scrubber and sharing functions. In addition to the standard player controls, features include “create a tag” and “make a request” buttons and the item information queue 112 (e.g., see FIG. 5). Content player 101 includes controls for selecting item information displayed. For example, a user may select a video, pause a video or other media file and select item information. The content player 101 provides additional information about the item, such as via thumbnails 13 at queue 112 as shown in FIG. 5. Users may investigate the thumbnails. This information (streaming video, item information) is primarily provided by server 200 via content player 201 and item identification information database 203.

For example, selection of a particular thumbnail 13 will prompt content player 101 to send a signal via the hosted website that will be received by server/processor arrangement 220. Server/processor arrangement 220 will process that signal via framework 110 to cause additional item information from identification information database 203 to display by content player 101 in association with the thumbnail 13. Alternatively or in addition, a landing page may be loaded to content player 101 taking the display (and therefore the user's experience) away from the streamed video file and displaying information available within the item identification information database 203 pertaining to the item. Or, a landing page may be loaded and take the content player 101 from the video file and to third party URL's and websites relating to the item.

Also, the website and content player 101 provide for searches, which similarly cause the item identification information database 203 to provide information about an item independent from streaming a video. For example, if a user enters a search term into the website or content player 101 (e.g., a famous actor such as “Tom Cruise”), the same landing page is loaded with all item information within the item identification information database 203 pertaining to the search term “Tom Cruise,” and without the content player 101 first streaming the movie “Top Gun” video file.

In the preferred embodiment, content server 201 is a cloud server that stores or accesses locally stored media files (including video files, web files and images). Content server 201 also accesses libraries and other databases that utilize third party content not stored on content server 201 (e.g., content held off location through services such as Akamai or Hulu, see further as described below).

Content servers 201 are utilized in at least two capacities for storing and streaming libraries of content (i.e., more than one content server 201 may be used). Some content servers may have special purposes, such as a content server 202 shown in FIG. 6 for storing user provided content. In a first capacity, content server 201 stores and streams libraries of content that are also provided with predefined and user defined tags from item identification database 203. In a second capacity, content server 201 also streams and manages streaming of media through content servers from third party media distributors. For example, third party media providers could include Hulu, Akamai, Youtube or Limelight. In addition or alternatively, an additional content server 202 streams and manages streaming of media that includes user uploaded video content which is stored on content server 202.

To illustrate further, the content player 101 is capable of accepting streaming media from content server 201 (or content server 202) and third party media delivery agents via content server 201. In the first instance, the content server 201 stores, retrieves and delivers media files. Content player 101 can play one of these media files when content server 201 streams the file to the content player 101. Alternatively, the source of the video file to content player 101 is from a user's media file loaded to content server 202. Via content player 101 and the hosted website, users can download their own media files to content server 202 via instructions processed by server/processor arrangement 220. The user's file is subject to review. The system converts the file if necessary (e.g., format). The system stores the user's file on the main content server 201 or ancillary content server 202. The system then streams that content to content player 101 in response to requests to play that user's video.

The second instance is where content is provided to content player 101 through third party media delivery agents via content server 201. For example, such third party media delivery agents include Fox, FX, HBO, CW or other outside content providers (e.g., Hulu, YouTube, Vimeo, Joost, Nextnewnetworks etc.). In some embodiments, content is provided via a broadband third party delivery agent (e.g., Akamai, Limelight). Broadband third party delivery agents hold the content of third party media delivery agents and other content owners. Third party media delivery agents or broadband third party media delivery agents deliver content to content server 201 to be delivered to content player 101. For these sources of content streaming, a link library (e.g., a list of URL's in communication with content server 201) and a third party item identification database is created on or in communication with the content server 201 and information database 203 to store the link locations of content to be accessed on third party file servers and made available to content players 101 via content server 201.

For example, the system can stream television episodes. Television episodes belong to third parties. Third party media delivery agents possess, store and otherwise hold the content of television episodes on third party servers. The content is available for streaming. For example, such an agent may hold a popular TV series, such as “Seinfeld.” The third party may hold all episodes of “Seinfeld: on a cloud file server with a broadband third party delivery agent. The broadband third party delivery agent provides a link to the episodes of the “Seinfeld” series within its servers. This link is incorporated into the system of the present invention. In other words, the system is modified to add a link library and third party item identification database for those episodes as a source of video content. For example, the content server 201 is programmed to search the link library and prompt the third party agent to deliver the episode to server 201, so that the episode can be streamed to one or more content players 101. The server 300 side of the system incorporates a third party item identification database for content referenced in the link library. Such third party item identification database may be loaded with predefined or user defined tags corresponding to third party content from various sources. Such a third party item identification database may be developed over time, in that tags can be added over time, whether through predefined tags via the system managers (e.g., librarians) or through users. Such third party item identification database works in the same manner as item identification database 203 and may be incorporated as part of item identification database 203 or content player 201 (or in communication with same). Content from third parties remains as video or other media files. Third party item identification databases can be used when such third party video or other media files are streamed. In the same fashion as described above for item information from item information database 203, server/processor arrangement 201 processes instructions to obtain third party information in such third party information databases to the display of tags on content player 101 at predetermined times.

Accordingly, the third party delivery agent is linked to the system of the present invention, and the system has loaded a link library corresponding to the content available via the third party. The system can then stream a media file, such as a certain TV episode in the foregoing example. A user selects an episode they would like to watch via the content player 101. The content player 101 references the selected episode to the content server 201 via server/processer arrangement 220. The content server 201 is provided the link reference to the episode identified in the link library corresponding to the actual media file with the episode in the third party media agent's database or delivery system. The system sends a request to the third party delivery agent or broadband third party delivery agent to deliver that content via the link referenced by content server 201 (e.g., see HTTP server block in content server 201 in FIG. 6). The third party delivery agent delivers/transmits the media file. The third party item identification database delivers tags in the same fashion as item identification database 203 for other content. The media file and tags are uploaded. The media file is streamed on content player 101 and the tags are displayed at the predetermined times corresponding to the media file and item information.

Describing the item information database 203 in more detail, this database is responsible for managing and distributing the information detail relating to items (e.g., products, celebrities, locations, songs and individuals) paired to streaming content. During the process of displaying (or “markering”) items during playback, this item information database 203 is queried. In other words, on client side 100, the system displays video 11 from content player 201 and tagged item information from item information database 203 on content player 101 when video 11 is played. Tagged item information displays when the timeline of the media file reaches pre-determined time markers. When each time marker is reached, an item marker animates on the display at the x, y coordinates at that time on content player 101. Information from the item identification database is accessed and displayed. This can be done selectively depending on the items to be displayed.

In further detail, through coded instructions processed by the processor of content player 101 and server/processor arrangement 220, content player 101 monitors for a signal. The signal is in accordance with item information from the item information database 203 and media file from content player 201 via server/processor arrangement 220. The item information and media file are associated by time markers corresponding to the timeline of the media file. Once a pre-determined time has been reached in association with the streaming media file, an instruction is sent to display item information from the item information database 203 to the content player 101 at x, y coordinates (e.g., at time 10 min, 23 seconds, display animated marker at x, y coordinates). Item information database 203 has relayed item information for display from a display field associated within the time marker field to the content player 101 screen (e.g., from a display information field or row in the information database table corresponding to the t, x and y coordinates of the marker). For example, marker and display field options in the item information database 203 include: Time|X|Y|First name|Last name|Brand name|Product name|Description|Manufacturer|Location|Artist Name|Thumbnail location|Landing page location. Each field is used respective to the item to be identified. For example, if the item is an actor, the first and last name would be revealed. If the item is a product, the brand name and description can be revealed, along with an appropriate thumbnail and landing page link.

Item identification information database 203 comprises one or more databases storing all the information related to tagged items (e.g., products, celebrities, locations, music, etc., for each item). This information is accessed via the content player 101 based on control and instructions provided and processed by server/processor arrangement 220. For example, streaming video plays in accordance with a timeline for the video. Content player 101 tracks time in association with the streaming video and item information in item identification database 203. In accordance with controls and integration from server/processor arrangement 220, server 200 causes item identification information database 203 to send item information to content player 101. Similarly, server 200 also causes content player 201 to send streaming media file to content player 101. The item information is matched to the streaming media (video) file by content player 201 by time and displayed by content player 101.

Ad server 106 provides access to loading pages for advertisements. Ad server 106 is responsible for delivering the website wide advertisements as well as advertisements in content player 101 and commercial ad rolls. Ad server 106 preferably provides advertisements via the website, not limited to commercial ad-rolls, banner ads, page sponsorships or takeovers and branded back-grounds. Yet, ad server 106 also includes access to advertising networks that deliver advertisements, such as Double-Click, Ad Serv, Google Ad-sense and Guerilla Nation. Code is installed on the ad server 106 that allows the inclusion, tracking and delivery of third party advertising networks.

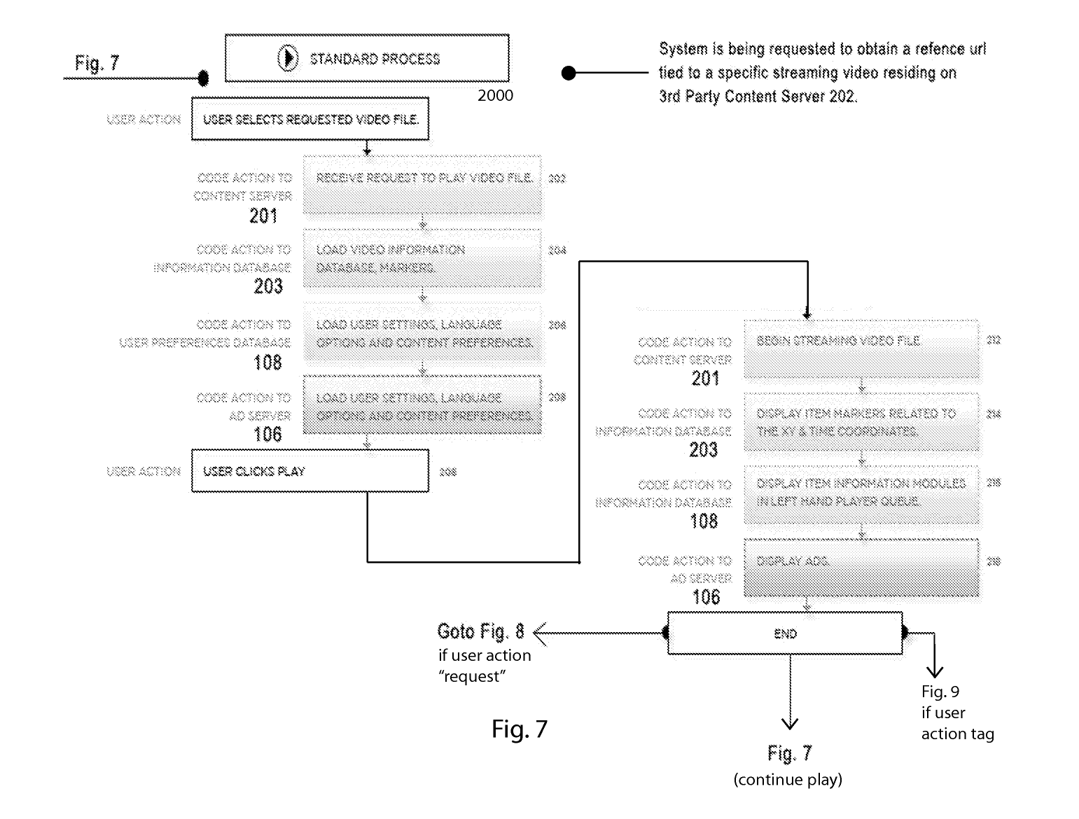

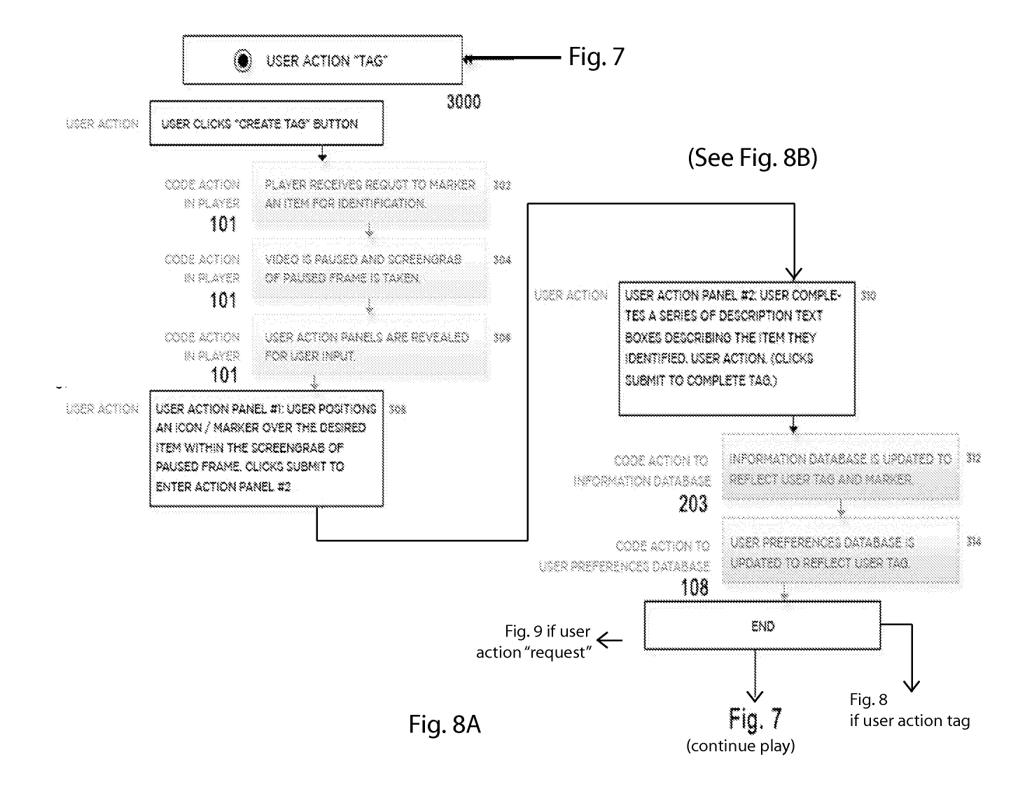

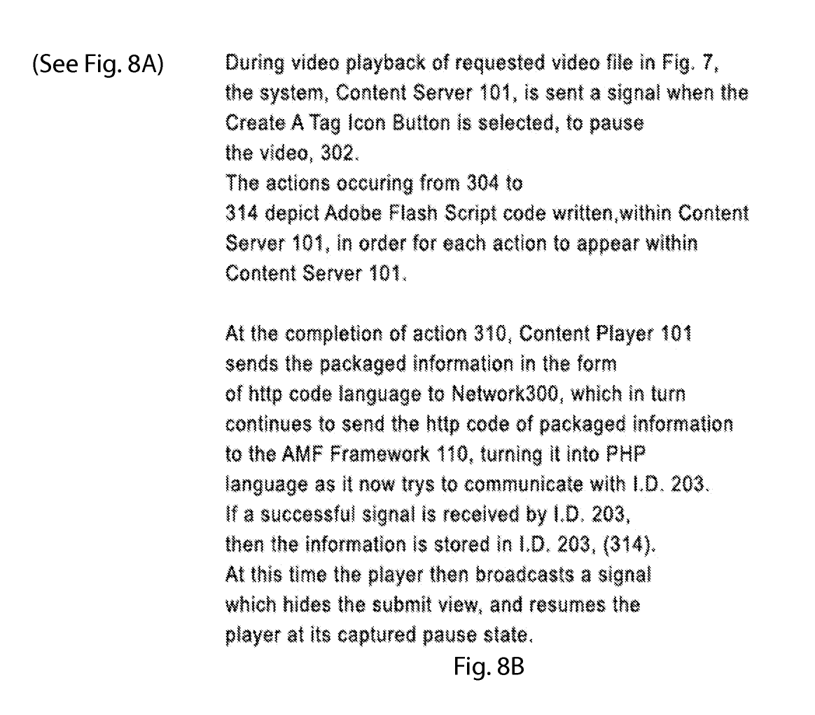

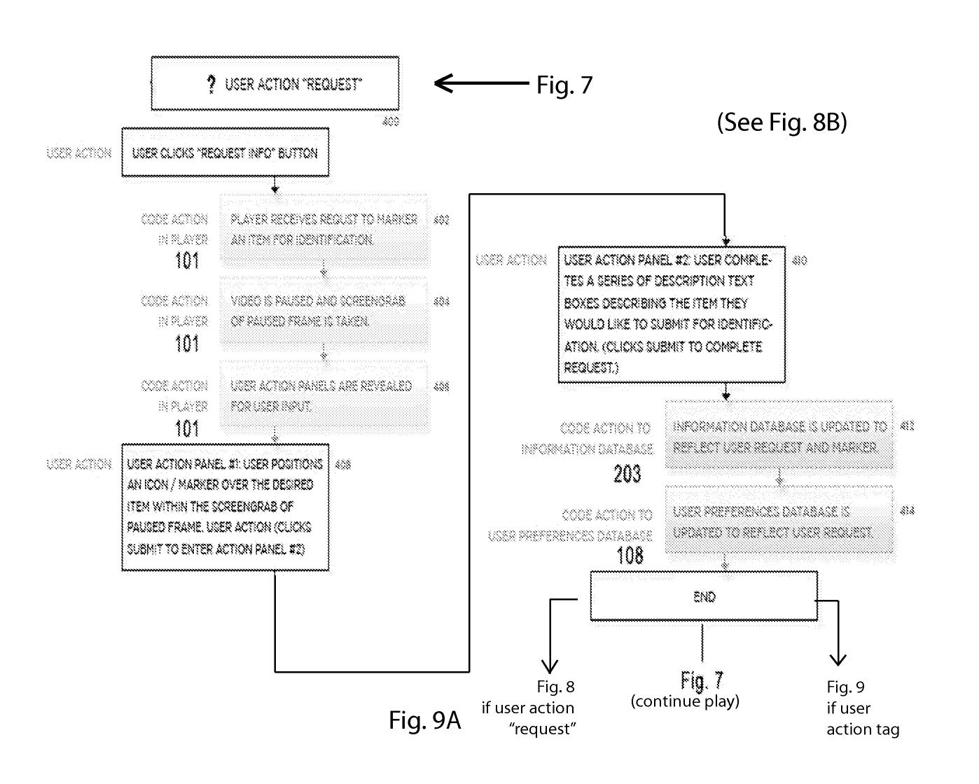

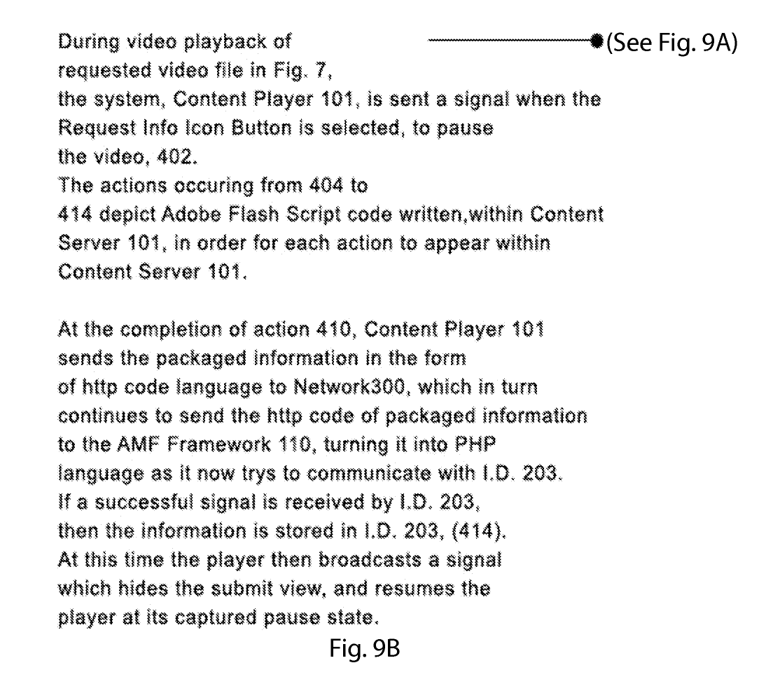

Ad server 106 works in a similar fashion as the content server 201. However, the system does not necessarily allow users to control the advertisements displayed. Information provided to or input by the user may provide information that controls the advertisements displayed, however. For example, in accordance with the processes illustrated in FIGS. 7, 8 and 9, the system provides users with options to select video files to watch via the content player 101. The content player 101 loads the video file and begins streaming the video file selected. At various pre-determined times, the content player 101 sends requests to the ad server 106 to load advertisement media files (e.g., an ad-roll commercial or in player advertisement). These requests are generated in response to the streaming media file, such as in response to predefined tags corresponding to products. Products have specific advertisement fields associated with them that correspond to advertisement media files or libraries of advertisement media files. Ads are also categorized based on the genre of the video-file being viewed and checked against user preference settings. Advertisement media files are displayed accordingly based on programmed requests predefined by the system to respond to advertisement fields associated to the media file. Advertisement fields are incorporated in the item information data base 203 in similar fashion to marker fields and display fields described above.

For example, the system streams media files showing certain content genre, such as X-games competitions (e.g., or extreme sports). When the media file is streaming, an advertisement field corresponding to marker field time t is reached. The streaming media is paused. The system delivers an advertisement (e.g., 15 sec. commercial ad) via the content player 101. The system does so in response to a request from content player 101 to the ad server 106 to send an ad for display that matches the theme of the X-games. If the system recognizes the user via user preference database 108, then the content player 101 will be instructed to recognize user preferences from user preference database 108. In response, the system will deliver an ad corresponding to the advertisement field and modified by the user preference information. This will depend on pre-defined categorical preferences of the user preferences database 108 in the user's profile settings.

User preference database 108 maintains profiles of user preferences. User preferences database 108 is responsible for the management and implementation of pre-defined user settings and controls in accordance with server/processor arrangement 220. This will include, without limitation, language options, targeted advertisement settings, share with friend settings for the pairing of social networks, and logic to pre-sort user preferred viewing habits for items and similar content.

The user preferences database 108 contains fields reflecting a series of pre-defined options and settings. These allow the system to recognize users via user identification information input to content player 101. This further allows the system to generate instructions and respond to requests from content player 101 to control customer content viewing preferences. Through these registered user control options, the system can modify features made available via the content player 101. For example, the system obtains information from registered users, such as age, location, gender, areas of interest and language preference. The system also obtains information regarding the user's viewing and purchasing habits. These are user preference fields. These are stored in the user preferences database 108. They are categorized according to each particular user to reflect user preferences and demographics. With these fields, the system tailors content played via content player 101. As a result, this allows system control of content provided to content player 101 based on user registration and preferences. For example, this provides for control of highly targeted ad delivery based on user preferences (e.g., including viewing and purchasing habits). For example, if registered user is registered as 18 year old male, in the western United States, interested in board sports and speaks/reads Spanish, then the system associates content accordingly.

Item and information queue 112 is for predefined products within the information database. Once an item has been revealed and marked during media playback, a thumbnail of the product and short description of the item are made available in queue form in association with (e.g., next to) the content player 101.

The item information database 203 and information queue 112 (e.g., see to the left of the player in FIGS. 5) work in tandem. Once a marker within the video has been displayed, the corresponding item information from the item identification information database 203 is provided. For example, this includes a name, brand name, thumbnail, description, and landing page link location. Information queue 112 displays item information relating to items in a video file until the video clip has ended and the associated information database rows originating from item information database 203 are exhausted. In regard to actionable code positions, the content player 101 and information queue 112 reside at the client side 100, with the item identification information database 203 populating the content player 101 and information queue 112 via server side 200. The information queue 112 includes additional information and features (e.g., website landing page associated to the item, add to my favorites, send to a friend, add to Wishlist, send to social network Twitter, Facebook or fffound). Taking an example where the queue 112 on the host website and/or the content player 101 provide for an option to go to the home page of the website for a tagged item, the user is prompted with the opportunity to select a link to the home page of the website (e.g., a link directed to: HTTP://www.[website]/media/xyz).

In any case, when the computer on client side 100 is given such an aforementioned URL (or URI), the computer looks for the server that the URL is hosted on (via network 300). An HTTP request is sent from the client side 100 via computer used by user, through the Internet 300, to server 200. When the server 200 receives the HTTP request (e.g., at server/processor arrangement 220), it will recognize the signal as a common website hyperlink and provide access to the requested URL and website. By further example, generic HTTP requests (requests not specifying a specific file: image.jpg, page.html, etc) are rerouted to HTTP://www.[website]/index.php. Since this is a PHP language file by example, the HTTP server, which is server/processor arrangement 220, recognizes this and processes the code in that file. This file looks at the entire URL contained in the request and responds (e.g., recognize and respond to “/media/xyz” based on preprogrammed instructions). This causes the server/processor arrangement 220 to respond by searching or processing instructions to search for the designated media page.

As such, upon receipt of URL's from the client side 100, the server side 200 has information regarding what the user has input for purposes of accessing via the website and/or content player 101. This applies to initiating the website and streaming of video via the content player 101 and continuing with other features of the system. In response, the server side 200 (e.g., server/processor arrangement 220) looks at the rest of the URL (e.g., “xyz”). This is the unique identifier for the video that has been input into the content player or website as a request. The server/processor arrangement 220 receives this and processes it. In response, using PHP as an example, the server/processor arrangement 220 takes this and forms a SQL query to be sent to the item identification information database 203.

For example (PHP script):

$media_id = ‘xyz’;
$database = new mysqli(‘localhost’, ‘username’, ‘password’,

‘[website]_information_database’);

$result = $database−>query(“SELECT media.media_title,

media.media_description FROM media

WHERE media.media_id = ‘“. $media_id .”’”);
$data = $result−>fetch_assoc( );

Continuing with this example of code, the 1^{st} line establishes a unique identifier. The 2^{nd} line connects to the item information database 203. The 3^{rd} line sends the SQL query to the database. $result now holds a copy of the data requested and queried for. Finally, the 4^{th} line formats the data. Once this process is completed, the data is formatted in HTML and handed back to the HTTP server (server/processor arrangement 220) to send the data to the location from where the request originated.

Once the HTML gets back to the client side 100 and the computer on which content player 101 runs and the website is accessed, it is displayed on the user's computer's screen. Embedded in the HTML is a bit of JavaScript as follows:

<script type=“text/javascript”>

$(document).ready(function( ){

$(‘#video-player’).flash(

```
{
  src: ‘HTTP://www.[website]/fsv/player.swf’,
  width: 975,
  height: 445,
  flashvars: {mediaId: ‘xyz’}
},
{version: 8}
```

);

});

</script>

The above script tells the user's computer browser that it needs to load the content player 101 into the web page. Client side 100 sends another HTTP request to server side 200 requesting player.swf via server/processor arrangement 220. The server 200 sends back the requested file and the client 100 puts it on the web page on user's computer.

Line 8 of the above script provides: flashvars: {mediald: ‘xyz’}. This is information that is passed to the content player 101 as it is loading. For example (HTTP/AS3 script):

public class LoadVideoDataCommand extends Command
{

[Inject]
public var proxy:VideoDataProxy;
override public function execute( ):void{
proxy.loadVideoData(Model.get(“main”).flashvars.mediaId);
}

}

Line 7 of the above code excerpt provides: Model.get(“main”).flashvars.mediald. This is the data passed with the javascript. That data is used to formulate a request to the server side 200. The above code generates a request to load video information to which server/processor arrangement 220 responds and directs content player 201 to eventually provide streaming video.

Continuing in detail, when the content player 101 sends such a request to server 200, its destination is HTTP://[website]/fsv/gateway.php. This is the main entry point to the AMF framework 110. An HTTP request along with additional information about the request is sent through internet 300 to server 200. The HTTP server (e.g., server/processor arrangement 220) accepts this request and locates Gateway.php and directs PHP programming to process the file.

Via the AMF Framework 110, the data from the request made by server/processor arrangement 220 is converted from format AS3 (AS3 is Adobe Action Script 3 which is the Flash code language) to format Javascript PHP which item identification database 203 recognizes/understands. Once that is complete, the function LoadVideoData is executed and the unique identifier is provided. This function sends a SQL query to the item information database 203 to gather all relevant data for the video with the unique identifier ‘xyz’.

The data that is returned by the information database 203 contains:

The title of the video

A short description of the video

The URL of the video file (which resembles

HTTP://c0470702.cdn.cloudfiles.rackspacecloud.com/donuzajokgtn.flv)

How many times the video has been viewed

Each item that has been tagged in the video

A title and description of each of these items

A URL to a small image of each item (once again, stored on a content server)

This data is then formatted, and the function LoadVideoData returns that data to the AMF framework 110 which converts the data into format more compatible with AS3 (e.g., Flash language).

Now that the request has finished processing, AMF framework 110 gives the returning data to the HTTP server (server/processor arrangement 220) to send back to the content player 101 via Internet 300 as an HTTP response. That request is now finished.

The content player 101 now has the information of the video to display and creates another HTTP request using the URL of the video (e.g., HTTP://c0470702.cdn.cloudfile&rackspacecloud.com/donuzajokgtn.flv). The request goes out into the internet 300 and finds its destination at the content server 201 (Rackspace Cloud). An HTTP server (e.g., including an HTTP server operating in accordance with 3^{rd} party servers) on or in communication with that content server 201 looks for the corresponding file (e.g., donuzajoktgn.flv) on its corresponding hard drives of memory, and, if found, an HTTP response is sent back to content player 101 and the file is sent to content player 101 as an HTTP stream.

As shown in FIG. 7, process 2000 describes steps provided by the system and method of the present invention whereby a user is provided with access to the website and content player 101 starting in a main or initial state (e.g., ready to display a streaming video). The system and method provide that the user can select a video file 11 for viewing from among multiple videos. The system and method play the video for the user on the content player 101. The system and method provide other options to the user, which the user may or may not select. At step 2022, the system has initiated a video based on a user using client 100 having selected a video file for viewing. A request to the content server 201 is sent asking to load the requested video file. The system and method begin to load the video to the content player 101 in the website browser for user computer. At 204, the video file has been selected, and a request is also sent to the item information database 203 to receive all item information paired with the user's requested video file and staged. At 206, the content player 101 queries on the user's preferences in user preference database 108 and associated settings database to load any pre-defined parameters. This includes language options, preferred item display settings, targeted advertisements and social network settings. If the user is not registered within the user database 108, this setting is skipped and all default settings are loaded.

At step 208, the content player 101 accesses the ad server 106 and begins making delivery requests against the settings loaded from the user preferences database 108. The site housing the content player 101 implements logic to target item and ad delivery against viewing habits and settings. This logic is used to pair advertisements within the ad server 106 and serve them according to requests from the content player 101.

At 210, the video 11, item information from item identification information database 203, ads from ad server 106 and user preferences from user preferences database 108 have been loaded. The system responds to the user selecting the play media button of the content player 101. At 212, the requested video file begins streaming to the user. At 214, at pre-defined time intervals during video playback, an item that is shown within the video has detailed item information relating to it stored within the information database. Once each time is reached, an event is initiated within the player 101 to display a marker at a pre-determined x and y coordinate within the content player 101 window notifying the user that additional information is available relating to that specific item.

At 216, once the marker is displayed, a second event is initiated within the player that loads a small detail tab (queue 112) within an information panel available on the side panel of the media content player. Within this detail tab is a thumbnail 13, which includes a brief description and a link to a landing page for further information about the item that was just marked within the streaming video content. Steps 214 and 216 are repeated until all information within the information database relating to that specific media file is exhausted.

At step 218, during video playback, the content player 101 will access the ad server 106 and deliver advertisements in the form of commercial ad rolls, banner ads and unique sponsorship arrangements that at certain time segments will initiate events that will change the entire page environment around the content player 101.

The below process and code further describes the cooperation of steps shown in FIG. 7.

Upon first load, the content player 101 stores a reference to a requested media identifier or media ID (a unique identifier to the item information database 203; identifier of video and all pertinent item information related thereto) in its internal data model. It then sends a request to load the data model for the player's initialization. For example (HTTP/AS3):

override protected function onModelReady( ):void{

model.flashvars = flashvars;
model.xml = <model></model>;
Model.set(“main”,model);
super.onModelReady( );

}

When the model, which is the unique id information of packaged data being requested, is ready, the content player 101 then sends a signal, which invokes a command (LoadVideoDataCommand) to request information from the item information database 203. This command uses the media ID given to the content player 101 to request the information required for the content player 101 to load a video and display the associated items and information. For example (HTTP/AS3):

public class LoadVideoDataCommand extends Command
{

[Inject]
public var proxy:VideoDataProxy;
override public function execute( ):void{

proxy.loadVideoData(Model.get(“main”).flashvars.mediaId);

}

}

In the file referenced above, “VideoDataProxy,” the system facilitates communication to the item information database 203 preferably using Guttershark Service manager. This is a utility used to create a connection to AMF framework 110 as a service. A service is a connection to information, i.e., go to xml file, execute, go to lines of code, execute process, go to URL, do this, if fail, go to this secondary URL. These are service calls that get executed in step order. Preferably, Gutter Shark is the system used to send the service calls out. The following is an example (Flash AS3 code):

public function VideoDataProxy( ){

super( );
serviceManager = new ServiceManager( );
serviceManager.createRemotingService(“videoData”,

“HTTP://[website]/fsv/gateway.php”,
“[website]_media.VideoData”,3);

}

LoadVideoDataCommand invokes the function loadVideoData on VideoDataProxy (which is associated to content player 101) using the media ID specified during initialization and calls for the requested data from the AMF framework 110 service “videoData.get” (command sent through the service to retrieve). For example (Flash AS3 code):

public function loadVideoData(mediaId:String){

serviceManager.videoData.get({params:[mediaId],

onResult:handleCallResult,
onFault:handleCallFault});

}

Upon successful loading, “handleCallResult” provides instruction to store the video in content player 101 and ready other components (e.g., content server 201, ad server 106, alternative or ancillary content server 202 in FIG. 6.) and the associated server/processor arrangement 220, and then instructs the system to process and store the returned information, and then broadcast a signal that the data has loaded (VideoDataProxyEvent.VIDEO_DATA_LOADED).

If the service returns an error, the application sends a different signal, one that shows a system error (Flash AS3 code):

(ApplicationFacade.ERROR)
private function handleCallResult(cr:CallResult):void{

if(cr.result.status){

var videoInformation:*= cr.result.video;
var products:* = cr.result.products;

| | |
|---|---|
| vo.bumper | = videoInformation.bumper; |

| vo.length | = videoInformation.length; |
|---|---|
| vo.subject | = videoInformation.name; |
| vo.thumbnail = videoInformation.large_thumb_uri; | |
| vo.uri | = videoInformation.media_uri; |

for each (var product:Object in products){

Model.get(‘products’).all[product.display_time] =

{‘company’:product.company_name,

‘URL’:product.company_URL,
‘time’:product.display_time,
‘name’:product.product_name,
‘x’:product.x_coord,
‘y’:product.y_coord

};

}

}else{

sendNotification(ApplicationFacade.ERROR, {text:“Video not

found”});

}
//store the data
Model.get(‘flv’).videoData = vo;
//broadcast signal
dispatch(new

VideoDataProxyEvent(VideoDataProxyEvent.VIDEO_DATA_LOADED, { }));

}

The event named VideoDataProxyEvent.VIDEO_DATA_LOADED broadcasts a signal that instructs components of the content player 101 that the information is ready.

Specifically, on “FLVViewMediator,” the “View Mediator” responsible for loading the URL (or URI) of a specified video into a Flash FLVPlayback component (content player 101) also adds the provided tag markers or spots (aka, cues, cue points, markers). For example (Flash AS3 code):

private function
handleVideoDataLoaded(event:VideoDataProxyEvent):void
{

flvView.loadVideo(model.get(“flv”).videoData.uri);
for each (var product:Object in model.get(“products”).all){

view._playback.addASCuePoint(product.time, product.name);

}

}

This event also triggers other view components of the content player 101 to load the landing view thumbnail 13 and display relevant information about the video (total tags, total favorites, etc). This event also triggers the content player 101 to add interaction to the pause and play buttons and to bring the content player 101 into a state ready for user input.

As such, when a user clicks the play button (e.g., see 208), it broadcasts a signal that instructs to play the video, to hide the video overlay, and to enable the video to start broadcasting spots (e.g., “spots” and associated item information of tagged items; see e.g., FIG. 4).

While the video is playing, the server side 200 of the system is checking for tagged/identified items specified at the current time. When a tagged item arises at the current time, a custom signal is broadcast from content player 101 that notifies the server/processor arrangement 220 (including HTTP server) that a tagged item has been encountered in the streaming video and renders the relevant information. The rendering of information is characterized by components provided to the content player 101 from the backend server side 200. These include, without limitation, the “spot” (or cue) player component which renders the spots, the product list component which renders item information from item identification database 203 and the information queue 112 (list of all items). The components are front end modules that render and display. For example, the spot layer component (the concentric circle spot that shows up next to the product or item that has been tagged as shown in FIG. 5) pulses a spot over top of the video at the specified x, y coordinates provided by data model for the spot point. As another example, thumbnails 13 are rendered as overviews of recognized “spots” to the left of the video display by the content player 101.

Continuing on with respect to FIGS. 8 and 9, the below actions may be achieved by customized code as well. As such, these processes are determined by events. Events correspond to sets of signals sent to the content player 101 which results in a front-end action viewable by the user. Events are often in response to signals from the user (e.g., user input to the content player 101 or website).

FIG. 8 illustrates the steps to creating a tag. In sum, a video is streaming, the content player 101 pauses and a screen grab is taken of the paused frame. A window loads within content player 101 showing the screen shot and a toolbox giving the user the needed tools to create a spot/marker on the item they wish to indentify. Once the spot/marker is placed, the x, y and t coordinates are captured and staged to be written to the item information database 203. Once the tagging/markering has been completed, the user selects “continue” to load the second and final window, presenting the user with a series of text boxes and drop down options to categorize and detail the item further. Text boxes and drop down fields will match the rows and categories available within the information database (e.g., Name|Brand|Style|Image|Link|etc.). Once this action has been completed, the user clicks “submit” and the updated information is written to the item identification information database 203.

As shown further in FIG. 8, the user action “create a tag” (or “request a tag”) 3000 refers to this process of accepting user input regarding item information and adding that to item information database 203. For example, if during the playback process a user sees an item they recognize, such as an actor on screen or location currently being displayed, user may select the “create a tag” option provided by media content player 101 of the client 100. Once user has clicked the “create a tag” option or button within the video player, at step 302, the player initiates an event that loads a series of information panels for user input. At step 304, a screen-grab is taken of the current frame and the time-code is logged and staged for addition to the item information database 203. At step 306, information fields are made available to the user through the content player 101 to begin a two-step process for “creating a tag” and updating the item information database 203.

At 308, when the first panel is revealed to user, the screen-grab taken previously is displayed, and a tool panel is provided to allow the user to drag a marker over the screen-grab to position over the item they select to identify. Once the user has positioned the marker and is content with its placement, the user then selects a “continue” or “submit” option or button. The updated information is received by the content player 101 and staged for addition to the item information database 203.

At 310, at this point, the content player 101 then initiates an event that loads an information request panel with a handful of text fields for user input. These fields are used to create the detailed information relating to the item being marked. Content player 101 will provide questions (e.g., name, manufacturer, web address, upload photo, artist, song name, celebrity or athlete name, etc.) depending on the type of item being identified. Content player 101 will accept user responses to the questions.

At 312, as the user completes this process, the new information is then sent to the information database 203 and logged. The time-code and x, y coordinates for the item are logged and updated. At 314, the user preferences database 108 is updated to reflect the recent tag and interaction.

Continuing in further detail with respect to FIG. 8, when a user clicks the tag or request button (e.g., see FIGS. 3, 5), the content player 101 broadcasts a signal which invokes the “SpotCommand” which pauses the video, takes a snapshot of the players current state and stores it for resuming. This also invokes a command and displays a quick entry form for the user to either add a tag, or request a tag.

Using the controls provided by the content player 101, after a user clicks on the paused video to place their tag at an x and y coordinate, they fill out the requested information. They click “submit,” and the content player 101 application broadcasts a signal that validates the information entered into those fields (e.g., product title, link to product). Upon successful validation, the application stores this information locally, then initiates a request on SpotProxy (initiates the spot command, sends the call to the server, initiates a product information call) to send this information to the item information database 203. Preferably, Guttershark is used. Again, GutterShark is a macros service manager to connect to the AMF framework 110 service. For example (Flash AS3 Code):

public function SpotProxy( ) {

super(NAME, new VideoVO( ));
var URLRequestSession = ‘?sid=’+
CookieUtil.getCookie(“[website]”)

| | |
|---|---|
| +‘&miv=’+ | CookieUtil.getCookie(“peiv”); |

serviceManager = ServiceManager.gi( );
serviceManager.createRemotingService(“spotProxy”,

“HTTP://dev.parrazi.com/amf/gateway.php”+URLRequestSession,

“parrazi.SpotProxy”,3);

}

To send the information, “submitProduct” is called, and packages the information to be sent to the service, and then calls the service. For example (Flash AS3 code):

public function submitProduct(formInfo:Object):void{

var callParams:Object;
with(callParams)
{

category = formInfo.category;
name = formInfo.name;
description = formInfo.description;
_xpos = formInfo._xpos;
_ypos = formInfo._ypos;
popupTime = formInfo.popupTime;
addedTime = formInfo.currentTime;
URL = formInfo.URL;

}
serviceManager.spotProxy.submitProduct({params:[ formInfo],

onResult:handleCallResult,
onFault:handleCallFault});

}

When this information is sent successfully, and the AMF service 110 returns a successful submit, the content player 101 then broadcasts a signal which hides the submit view, and resumes the content player 101 at its captured pause state.

As such, FIG. 8 illustrates the steps to the “create a tag” option. The foregoing operations of FIG. 9 and the “request information” tag option are similar but directed to the specific option of requesting information rather than creating a tag.

As shown in FIG. 9, the “create a request” process 400 refers to providing an item to a user through site-wide crowd sourcing for identification. For example, if during the playback process a user sees an item they wish to know more about, that has not previously been cataloged in the information database, such as an item seen on screen or location currently being displayed, the system allows user to select the “create a request” option.

At step 402, after the system receives an affirmative selection of “create a request” (the signal) within the content player 101, the player initiates an event that loads a series of information panels for user input. At 404, a screen-grab is taken of the current frame and the time-code is logged and staged for addition to the information database. At 406, information fields are made available to the user through the player to begin a two-step process for creating a request (by user) and updating the item information database 203. At 408, the first panel is revealed to our user, the screen-grab taken previously is provided, and a tool panel is provided allowing user to drag a marker over the screen-grab to position over the item to request. Once the user has positioned the marker, the user then selects the “continue” or “submit” button. In response, the updated information is received by the content player 101 and staged for addition to the item information database 203.

At step 410, at this point, the content player 101 initiates an event that loads an information request panel with a handful of text fields for user input. These fields are used to create the request that will be submitted. Questions will include identifiers to assist in the identification of the item. At 412, the user completes this process, and the new request is then sent to the information database and logged. The time-code and x, y coordinates are logged and updated. At 414, the user preferences database 108 is updated to reflect the recent request and interaction within the player 101.

As noted above, computer program listings are submitted herewith and incorporated herein by this reference. These further describe the invention and the references to code above.

In sum, three main user actions are involved. First, the system provides a process 2000 whereby videos are played on the content players 101 and tagged items are displayed. Second, in an item tag or identification process, during the playback process of a streaming video file, a user can choose to identify an item that has not been identified or cataloged within the item database. This is provided by an option to “create a tag” process 300 and two steps or parts to identify an item within that particular streaming video clip.

In part one, the system provides an option to “create a tag” and launch the item identification process. When this option is selected, a screen grab is taken of that frame and the time coordinates are locked. A dialog box is opened within the content player 101 window, presenting the screen grab just taken, and reveals a toolbox option with the marking system. The user then drags the marker over the item they wish to identify and selects submit.

In part two, once the user submits the screen grab with the positioned marker, the system then locks the x, y positioning coordinates, file name, time code and applies them to the database 203. At this moment, a second dialog box is provided to request a user to complete a brief questionnaire regarding that item: name, item manufacturer, description detail, link to item available elsewhere on the Internet, etc. The user then clicks submit to send the information to the item information database 203.

Example:

Name: Mustang '67

Manufacture: Ford

Description: Black and silver 1967 ford mustang fastback, hertz special edition

Link: www.ford.com/mustang

- - -

File: gone in 60 seconds

Time: 65 min 17 secs

X coordinates: 75.3

Y coordinates: 12.189

Verified user: yes

Submit for review: no

Update database: yes

At this stage, the item identified by the user goes through a series of checks and balances to verify authenticity against spam filters, duplicates and additions to the item database 203. If this item clears the verification process a marker is applied and the video file is updated. If this item fails to clear the verification process, it gets submitted to an item queue for review and approval or removal.

Example:

Name: Yankee's tickets for 19.99

Manufacture: Bobs sports authority and ticket warehouse

Description: get your season tickets now with the world's leading ticket warehouse.

Link: www.bobstickets.com

- - -

File: Gone in 60 Seconds

Time: 65 min 17 secs

X coordinates: 75.3

Y coordinates: 12.189

Verified user: no

Submit for review: yes

Update database: no

Third, the system provides a request process. This process 400 works in similar fashion, allowing users to make an item identification request for items seen within a streaming video clip. Once a user selects the “make a request” option within the player 101 controls, the same series of dialog boxes appear allowing a user to tag (identify for display/markering) an item and submit a request to have that specific item reviewed. Upon a successful completion and submission of an item identification request, a unique marker is applied to the x, y and time coordinates of that specific video file, notifying users that the item shown at a certain time (e.g., 19:31) is marked for identification and logged to the database 203.

The access of item information from item information identification database 203 by the system works in essentially the same way in each case. A video file is loaded, the “create a tag” or “make a request” buttons are clicked, and launch a series of events that write to the information database 203 and are linked to the video file at a certain time code.

In addition, the system provides a user sharing environment. For example, a user can stream a video and add tags based on their user defined preferences. These user defined tags are incorporated into the item identification database 203 and made available to one or more content players 101 via content server 201 as described above (e.g., see FIG. 8). Accordingly, a second user can subsequently view the same video and access user one's tags. Users can share and add tags over time with respect to a common media file, including user provided media files.

In connection with the tag and request system, a player wrapper application that overlays third party content on top of the framework of the content player 101 is provided. The system can “re-skin” the player 101 to the look and feel of a particular brand. Through this adaptive video player wrapper, the system will provide for embeddable widgets within a brand's website.

This present invention also preferably integrates encryption protection (e.g., such as via Amayeta Flash.swf HTTP://www.amayeta.com/software/swfencrypt/). The invention also preferably includes encryption of the data connection between the media content player 101 and backend server side 200 data servers for security protection. Encryption protects the media content player 101 from the flash decompilers and reverse engineering tools. In the event the media content player 101 were reverse engineered or decompiled, the data requests to the server side 200 are encrypted and secured.

While the SYSTEM AND METHOD FOR TAGGING STREAMED VIDEO WITH TAGS BASED ON POSITION COORDINATES AND TIME AND SELECTIVELY ADDING AND USING CONTENT ASSOCIATED WITH TAGS as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A computer-implemented method for receiving or providing supplementary content for presentation in synchronization with playback of video content, the method comprising:
receiving, from one or more content providers over a network, the video content, the supplementary content and synchronization information, wherein the synchronization information indicates an x coordinate, a y coordinate and a time value associated with a frame of the video content, and wherein the synchronization information associates a first portion of the supplementary content with the frame; and
storing the supplementary content and the synchronization information.

2. The computer-implemented method of claim 1, further comprising:
sending the supplementary content and the video content to a computing device; and
causing, based on the synchronization information, the computing device to display, at or near the x coordinate and the y coordinate of the frame, the first portion of the supplementary content or a marker associated with the first portion of the supplementary content.

3. The computer-implemented method of claim 2, wherein the sending comprises:
sending the supplementary content in a first file and the video content in a second file.

4. The computer-implemented method of claim 2, further comprising:
creating an embedded file by combining the first portion of the supplementary content and the video content to create an embedded file; and
sending the embedded file to the computing device.

5. The computer-implemented method of claim 1, further comprising:
sending the supplementary content and the video content to a computing device;
causing the computing device to display the frame of the video content; and
causing the computing device to display a second portion of the supplementary content at a location adjacent to the displayed frame.

6. The computer-implemented method of claim 5, wherein the second portion of the supplementary content includes a link to a website.

7. The computer-implemented method of claim 2, wherein the first portion of the supplementary content is based on a user profile.

8. The computer-implemented method of claim 1, wherein the receiving comprises:
providing an image of the frame to one of the one or more content providers;
receiving, from the one of the one or more content providers, an indication of the x coordinate and the y coordinate of the frame; and
receiving, from the one of the one or more content providers, the first portion of the supplementary content.

9. An apparatus for identifying supplementary content to be presented in synchronization with playback of video content, the apparatus comprising:
a processor;
a machine-readable storage medium including one or more instructions executable by the processor for:
receiving, from one or more content providers over a network, the video content, the supplementary content and synchronization information, wherein the synchronization information indicates an x coordinate, a y coordinate and a time value associated with a frame of the video content, and wherein the synchronization information associates a first portion of the supplementary content with the frame; and
storing the supplementary content and the synchronization information.

10. A computer program product comprising a computer usable medium having a computer readable program code embodied therein, said computer readable program code adapted to be executed to implement a method for receiving or providing supplementary content for presentation in synchronization with playback of video content, the method comprising:
receiving, from one or more content providers over a network, the video content, the supplementary content and synchronization information, wherein the synchronization information indicates an x coordinate, a y coordinate and a time value associated with a frame of the video content, and wherein the synchronization information associates a first portion of the supplementary content with the frame; and
storing the supplementary content and the synchronization information.
